(19) United States
(12) Patent Application Publication
(10) Pub. No.: US 2023/0038310 A1
(43) Pub. Date: Feb. 9, 2023

(54) Devices, Methods, and System for Heterogeneous Data-Adaptive Federated Learning

(71) Applicant: Huawei Technologies Co., Ltd., Shenzhen (CN)

(72) Inventors: Lixuan Yang, Shenzhen (CN); Cedric Beliard, Boulogne Billancourt (FR); Dario Rossi, Boulogne Billancourt (FR)

(21) Appl. No.: 17/970,925

(22) Filed: Oct. 21, 2022

Related U.S. Application Data
(63) Continuation of application No. PCT/EP2020/061440, filed on Apr. 24, 2020.

(51) Int. Cl. G06N 3/04

(52) U.S. Cl. CPC G06N 3/0454; G06N 3/0472

(57) ABSTRACT

A client computing device and a server computing device for federated machine learning. The client computing device is configured to receive a model comprising a set of common layers and a set of client-specific layers from the server computing device. After a training at the client computing device, the set of common layers and the set of client-specific layers are both updated. The set of updated common layers is sent to the server computing device, and the set of updated client-specific layers is stored at the client computing device. The server computing device is configured to receive multiple sets of updated common layers from different client computing devices.

### CROSS-REFERENCE TO RELATED APPLICATIONS

This application is a continuation of International Patent Application No. PCT/EP2020/061440, filed on Apr. 24, 2020. The disclosure of the aforementioned application is hereby incorporated by reference in its entirety.

### TECHNICAL FIELD

The present disclosure relates generally to the field of machine learning. More particularly, the present disclosure relates to a client computing device, a server computing device, and corresponding methods for performing heterogeneous data adaptive federated machine learning. In particular, the server computing device and one or more client computing device(s) together employ a divided neural network for implementing the machine learning.

### BACKGROUND

Neural networks are used increasingly for performing machine learning to solve problems, e.g., network problems, and enable automation in diverse fields such as communication network systems. Conventionally, a model of a neural network is trained on a server by collecting data from clients, and forming a centralized dataset based on the collected data. The server may further adjust parameters (weights and/or biases) of the model until a certain criterion is fulfilled, for example, a convergence of a gradient descent of the neural network. The model is accordingly trained on a single dataset, which generates portability and generalization issues.

Moreover, with increasing concerns about data privacy, such as imposed by requirements from the General Data Protection Regulation in the European Union, new machine learning techniques are desired.

### SUMMARY

A federated learning approach would allow a plurality of client devices to train a shared model collaboratively with a server, while keeping training data on each client device, and not sharing the training data with the server. Such a sharing of a model may additionally allow saving data transfer volume, and may reinforce generalization capabilities of the model.

After every training, each client device would have improved the shared model, and would send an update of the shared model to a server. The shared model could then be optimized by averaging the updates from the client devices in the server. The shared model could be distributed again to the client devices by the server for further improvement and/or application.

However, several problems are identified for a conventional federated learning framework in a real environment, especially for traffic analysis and classification in communication networks.

First, an optimal model on a global distribution may be sub-optimal on a local distribution, due to environmental variance and feature imbalance. In particular, network traffic flows may differ with respect to each client device. For example, network traffic for streaming and texting of a client device from Europe may be, e.g., mostly from YouTube™ and WhatsApp™ respectively, whereas network traffic for streaming and texting of a client device from China may be, e.g., mostly from YouKu™ and WeChat™, respectively. Thus, the updated model of the conventional federated learning might diverge when applied on either one of the client devices from Europe or from China when features from both regions are combined and averaged in the shared model.

Second, signatures or features for a same network traffic may differ across environments due to multimodality. In particular, different data encapsulation and different numbers of packets are used in different communication networks. For example, a piece of voice message can be carried using different encapsulation and different number of packets by a Point-to-Point Protocol over Ethernet (PPPoE) protocol and by a Virtual Local Area Network (VLAN) protocol. These signatures or features corresponding to the same network traffic but in different communication networks are not portable, but are nevertheless updated to the server following the conventional federated learning framework in the shared model. Therefore, the updated shared model of a conventional federated learning framework may diverge when the same client device is used in a different environment where a different data encapsulation and a different number of packets are used.

Third, labels for different applications in the network traffic may not completely overlap across environments. Specifically, a local network may have labels that do not appear in another local network. For example, labels for applications such as Systems, Applications, and Products (SAP), Slack and team working applications that exist in an enterprise network are not likely to appear in a local network of a private home where labels for applications are mostly entertainment applications such as streaming and gaming, and vice versa.

Overall, a conventional federated learning framework aims only at achieving an optimized global model for all client devices, in order to perform a specific task of machine learning. However, since each local dataset differs more or less from a global dataset, an optimized global model does not have an optimal performance when applied individually on each client device in terms of each local dataset.

Therefore, in view of the above-mentioned problems, embodiments of the present disclosure aim to improve the conventional federated learning framework. An objective is to improve local accuracy of a model of a neural network on each client device, while achieving generalization across client devices.

The objective is achieved by the embodiments of the present disclosure as described in the enclosed independent claims. Advantageous implementations of the embodiments of the present disclosure are further defined in the dependent claims.

A first aspect of the present disclosure provides a client computing device configured to obtain a model of a neural network from a server computing device, in which the model comprises a set of common layers and a set of client-specific layers. The client computing device is configured to train the model based on a local dataset to obtain an updated set of common layers and an updated set of client-specific layers, in which the local dataset is stored at the client computing device. The client computing device is configured to send the updated set of common layers to the server computing device and store the updated set of client-specific layers.

By separating the model into the set of common layers and the set of client-specific layers, the client computing device is able to contribute to the training of the model by sending the updated set of common layers, after a training, and is also able to store the updated set of client-specific layers adapted to unique features of its local dataset (e.g., a local data distribution). Thus, a global accuracy of the model can be assured, while a local accuracy is also improved. Further, generalization across client devices may be achieved.

In an implementation form of the first aspect, the set of common layers are stacked prior to the set of client-specific layers.

In a further implementation form of the first aspect, the set of common layers comprises information for feature extraction and the set of client-specific layers comprises information for classification.

Training a model of a neural network, especially the set of common layers, requires a large amount of data, which may be stacked prior to the set of client-specific layers and/or may be used to extract features of the local dataset. By sending the updated set of common layers, even smaller amounts of data contained in the local dataset of the client computing device can contribute to the training of the model.

In a further implementation form of the first aspect, the client computing device is configured to perform feature extraction on the local dataset by using the set of common layers to obtain extracted features of the local dataset, and to perform classification of the extracted features of the local dataset by using the set of client-specific layers in order to train the model based on the local dataset to obtain the updated set of common layers and the updated set of client-specific layers.

Since features are extracted by the set of common layers, an amount of information required for classification is reduced. Therefore, less data is needed for training the set of client-specific layers, and the local dataset is sufficient for training the set of client-specific layers.

In a further implementation form of the first aspect, the client computing device is configured to use a normalized exponential function to output labels of the local dataset with probabilities in order to perform the classification of the local dataset.

Optionally, the normalized exponential function may be applied in an output layer or a last layer of the model. The output layer or the last layer of the model is used to output labels of the local dataset with probabilities. The normalized exponential function may be a softmax function.

In a further implementation form of the first aspect, the client computing device is further configured to receive an aggregated set of common layers from the server computing device, and update the model based on the aggregated set of common layers.

The aggregated set of common layers received from the server computing device may comprise aggregated information that is gained from datasets of other client computing devices. Therefore, the global accuracy may be improved, and the client computing device may benefit from this improved global accuracy by updating the model based on the aggregated set of common layers.

In a further implementation form of the first aspect, the client computing device is configured to concatenate the aggregated set of common layers and the updated set of client-specific layers in order to update the model.

As such, part of assuring global accuracy, i.e., the aggregated set of common layers and part of assuring local accuracy, i.e., the updated set of client-specific layers adapted to the unique features of the local dataset are concatenated and thus, the updated model has an optimal performance in terms of the local dataset.

In a further implementation form of the first aspect, the set of client-specific layers may comprise last fully connected layers of the neural network. Optionally, the set of common layers may comprise convolutional layers of the neural network. Optionally, the neural network may be a Convolution Neural Network (CNN).

A second aspect of the present disclosure provides a server computing device configured to send a model of a neural network to each of a plurality of client computing devices, in which the model comprises a set of common layers and a set of client-specific layers, and receive an updated set of common layers from each of the plurality of client computing devices.

By separating the model into the set of common layers and the set of client-specific layers, the server computing device is able to contribute to the improved training of the model in a collaborative manner with one or more client computing devices. Thus, a global accuracy of the model can be assured, while a local accuracy is also improved. Further, generalization across client devices may be achieved.

In an implementation form of the second aspect, the set of common layers are stacked prior to the set of client-specific layers.

In a further implementation form of the second aspect, prior to sending the model to each of the plurality of client computing devices, the server computing device may be configured to initialize each layer of the model with random values.

In a further implementation form of the second aspect, the set of common layers comprises information for feature extraction and the set of client-specific layers comprises information for classification.

In a further implementation form of the second aspect, the server computing device is further configured to aggregate the received updated sets of common layers to obtain an aggregated set of common layers, and to send the aggregated set of common layers to each of the plurality of client computing devices.

In a further implementation form of the second aspect, the server computing device is configured to perform an average function, a weighted average function, a harmonic average function, or a maximum function on the received updated sets of common layers in order to aggregate the received updated sets of common layers to obtain the aggregated set of common layers.

In a further implementation form of the second aspect, the set of client-specific layers may comprise last fully connected layers of the neural network. Optionally, the set of common layers may comprise convolutional layers of the neural network. Optionally, the neural network may be a CNN.

A third aspect of the present disclosure provides a computing system comprising a plurality of client computing devices and a server computing device. Each of the plurality of client computing devices is according to the first aspect or any of its implementation forms and the server computing device is according to the second aspect or any of its implementation forms.

A fourth aspect of the present disclosure provides a method performed by a client computing device comprising the following steps: obtaining a model from a server computing device, in which the model comprises a set of common layers and a set of client-specific layers; training the model based on a local dataset to obtain an updated set of common layers and an updated set of client-specific layers, in which the local dataset is stored at the client computing device; sending the updated set of common layers to the server computing device; and storing the updated set of client-specific layers.

In an implementation form of the fourth aspect, the set of common layers are stacked prior to the set of client-specific layers.

In a further implementation form of the fourth aspect, the set of common layers comprises information for feature extraction and the set of client-specific layers comprises information for classification.

In a further implementation form of the fourth aspect, the step of training the model based on the local dataset to obtain the updated set of convolutional layers and the updated set of client-specific layers comprises: performing feature extraction on the local dataset by using the set of common layers to obtain extracted features of the local dataset, and performing classification of the extracted features of the local dataset by using the set of client-specific layers.

In a further implementation form of the fourth aspect, the step of performing the classification of the local dataset comprises using a normalized exponential function to output labels of the local dataset with probabilities in order to.

In a further implementation form of the fourth aspect, the method further comprises receiving an aggregated set of common layers from the server computing device, and updating the model based on the aggregated set of common layers.

In a further implementation form of the fourth aspect, the step of updating the model comprises concatenating the aggregated set of common layers and the updated set of client-specific layers.

In a further implementation form of the fourth aspect, the set of client-specific layers may comprise last fully connected layers of the neural network. Optionally, the set of common layers may comprise convolutional layers of the neural network. Optionally, the neural network may be a CNN.

The method of the fourth aspect achieves the same advantages and effects as the client computing device of the first aspect.

A fifth aspect of the present disclosure provides a method performed by a server computing device comprising the following steps: sending a model to each of a plurality of client computing devices, in which the model comprises a set of common layers and a set of client-specific layers; and receiving, from each of the plurality of client computing devices, an updated set of common layers.

In an implementation form of the fifth aspect, the set of common layers are stacked prior to the set of client-specific layers.

In a further implementation form of the fifth aspect, the method further comprises initializing each layer of the model with random values.

In a further implementation form of the fifth aspect, the set of common layers comprises information for feature extraction and the set of client-specific layers comprises information for classification.

In a further implementation form of the fifth aspect, the method further comprises aggregating the received updated sets of common layers to obtain an aggregated set of common layers, and sending the aggregated set of common layers to each of the plurality of client computing devices.

In a further implementation form of the fifth aspect, the step of aggregating the received updated sets of common layers to obtain the aggregated set of common layers comprises performing an average function, a weighted average function, a harmonic average function, or a maximum function on the received updated sets of common layers.

In a further implementation form of the fifth aspect, the set of client-specific layers may comprise last fully connected layers of the neural network, and the set of common layers may comprise convolutional layers of the neural network.

The method of the fifth aspect achieves the same advantages and effects as the server computing device of the second aspect.

A sixth aspect of the present disclosure provides a computer program comprising a program code for performing the method according to the fourth or fifth aspect, or any of its implementation forms, when executed on a computing device.

In an implementation form of the sixth aspect, the computing device may be any electronic device capable of computing such as a computer, a mobile terminal, an Internet-of-Things (IoT) devices, etc.

In another implementation form of the sixth aspect, the computing device may be located in one device, or may be distributed between two or more devices.

In another implementation form of the sixth aspect, the computing device may be a remote device in a cloud network, or may be a virtual device based on a virtualization technology, or may be a combination of both.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description of specific embodiments in relation to the enclosed drawings, in which

FIG. 1 illustrates a model of a neural network used in embodiments of the present disclosure;

FIG. 2 illustrates a computing system according to an embodiment of the present disclosure, including a server computing device and a client computing device according to embodiments of the present disclosure;

FIG. 3 illustrates a computing system according to an embodiment of the present disclosure;

FIG. 4 illustrates a procedure implemented by a computing system according to an embodiment of the present disclosure;

FIG. 5 illustrates a method according to an embodiment of the present disclosure; and

FIG. 6 illustrates a method according to an embodiment of the present disclosure.

### DETAILED DESCRIPTION

Illustrative embodiments of device, system, method, and program product for computing are described with reference to the figures. Although this description provides a detailed example of possible implementations, it should be noted that the details are intended to be exemplary and in no way limit the scope of the application.

Moreover, an embodiment/example may refer to other embodiments/examples. For example, any description including but not limited to terminology, element, process, explanation, and/or technical advantage mentioned in one embodiment/example is applicative to the other embodiments/examples.

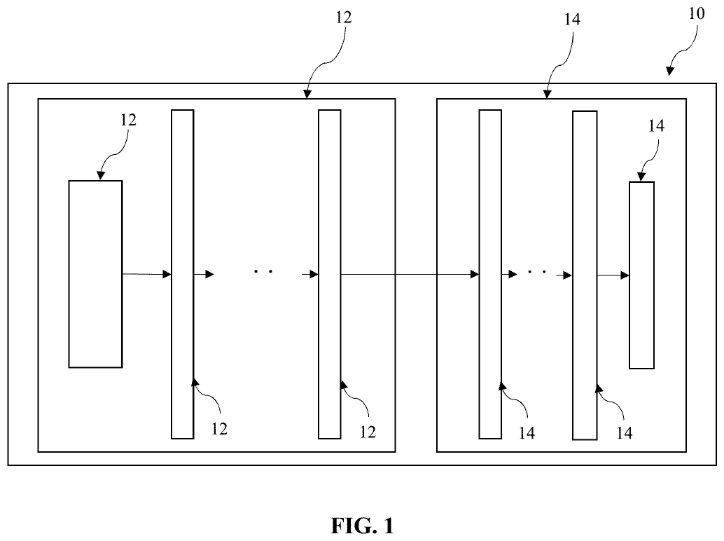

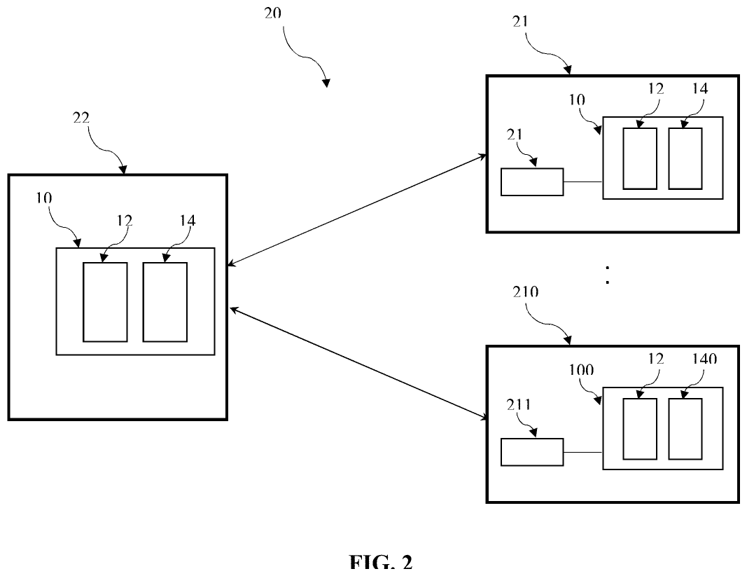

FIG. 1 illustrates a model 100 of a neural network, as it may be used in embodiments of the present disclosure. The model 100 may comprise an input layer 121, an output layer 143, and a set of intermediate layers 122, 123, 141, 142. These layers may be connected, one by one, wherein the output of one layer may be the input of the next layer. An idea of the present disclosure is to treat the model 100 as having two separate parts: a set of common layers 120 and a set of client-specific layers 140. A server computing device 220 (see FIG. 2) may provide each of one or more client computing devices 210 (see FIG. 2) with the model 100. Each of the one or more client computing devices 210 may, after training the model 100, share only the updated common layers 120 back to the server computing device 220 (see FIG. 2), and may store its updated client-specific layers 140 locally after the training. As such, the client-specific layers 140 may be kept independently across the different client computing devices 210, i.e., the client-specific layers 140 may not be shared by the client computing devices 210, and any updates relating to the client-specific layers 140 may not be sent to the server computing device 220.

This is beneficial, since a richer feature extractor may be possible for each client computing device 210 by sharing the common layers 120, while each client computing device 210 keeps its client-specific layers 140 adapted to unique features of its local dataset.

FIG. 2 illustrates (on the upper right-hand side) a client computing device 210 according to an embodiment of the present disclosure, and illustrates (on the left-hand side) a server computing device 220 according to an embodiment of the present disclosure.

The client computing device 210 is configured to obtain a model 100 of a neural network, e.g., the model 100 shown in FIG. 1, from the server computing device 220, wherein the model 100 comprises the set of common layers 120 and the set of client-specific layers 140. Each layer 120, 140 of the model 100 may further comprise parameters, e.g., learnable weights and/or biases, to be adjusted/trained for performing a specific task of machine learning.

The client computing device 210 accordingly obtains the model 100 from the server computing device 220, for example, as an initial model 100, i.e., prior to the training of the model 100. It may then train the received model 100 by using its local dataset 211. The parameters of each layer of the model 100 may be initialized, for instance, with random values by the server computing device 220.

The client computing device 210 is configured to train the model 100 to obtain an updated set of common layers 120 and an updated set of client-specific layers 140.

Thereby, parameters of each layer of the model 100 may be adjusted based on the local dataset 211 of the client computing device 210, for instance, by using a training algorithm commonly known in the field of machine learning, such as backpropagation. Alternatively, a part of the local dataset 211 may be used to adjust the parameters of each layer of the model 100. It is noted that the local dataset 211 may be stored in an internal storage unit of the client computing device 210, or may be stored in an external storage device attached to the client computing device 210.

After the training of the model 100, the client computing device 210 is configured to send the updated set of common layers 120 to the server computing device 220. Alternatively, the client computing device 210 may only send parameters of the updated set of common layers 120 that have been changed to the server computing device 220.

The updated set of common layers 120 may be adjusted according to common features of the local dataset 211. These common features may also be exhibited on another dataset 211′ of another client computing device 210′, which can be seen on the lower right-hand side of FIG. 2. For example, the local dataset 211 of the client computing device 210 may comprise chat messages and video streaming clips. The chat messages may usually comprise chunks of data that is of a format of plain text or encoded text, while video streaming clips may usually comprise chunks of media data conveyed by a real time streaming protocol. These features may also apply to other chat messages and video streaming clips of another client computing device 210′.

By sharing the updated set of common layers 120 with the server computing device 220, a global accuracy of the model 100 for performing the specific task of machine learning, such as identifying chat messages and video streaming clips in the above-mentioned example, can be improved across client computing devices 210, 210′.

Further, the client computing device 210 is configured to store the updated set of client-specific layers 140. The updated set of client-specific layers 140 may be adjusted according to unique features, which are rarely exhibited on other datasets 211′ of other client computing devices 210′. In particular, the updated set of client-specific layers 140 may be stored locally and/or may be stored as private layers at the client-computing device 210. That is, the updated set of client-specific layers 140 may not be sent to the server computing device 220 and may not be shared with other client computing devices 210′.

For example, the local dataset 211, as mentioned in the previous example, may comprise chat messages. The chat messages may be generated by a specific chatting software on the client computing device 210, and may be encapsulated in a specific format, which is only fit for this specific chatting software. These features may thus be unique for the local dataset 211 of the corresponding client computing device 210. The updated set of client-specific layers 140, if they would be shared, could cause interference or confusion to another client computing device(s) 210′.

Hence, by storing the updated set of client-specific layers 140, in particular only at the client computing device 210, a local accuracy of the model 100 for performing the specific task of machine learning may be improved, while interference or confusion to other computing device(s) 210′ may be reduced. Moreover, the model 100 may be adapted quickly to a local data distribution, despite an imbalanced global data distribution between the client computing devices 210′.

In one embodiment, the set of common layers 120 may be stacked prior to the set of client-specific layers 140. Optionally, the set of client-specific layers 140 comprises less parameters than the set of common layers 120. More specifically, any layer from the set of client-specific layers 140 may have less parameters than any layer from the set of common layers 120. As such, the set of client-specific layers 140 may require less data for the training than the set of common layers 120.

In another embodiment of the client computing device 210, the set of common layers 120 may comprise information for feature extraction, and the set of client-specific layers 140 may comprise information for classification. Moreover, the client computing device 210 may be configured to perform feature extraction on the local dataset 211 by using the set of common layers 120, in order to obtain extracted features, and to further perform classification of the extracted features of the local dataset 211 by using the set of client-specific layers 140.

In this embodiment, the set of common layers 120 may be used to extract common features of the local dataset 211, and the set of client-specific layers 140 may be used to classify the extracted common features and generate an output corresponding to the local dataset 211.

Further, for classifying the extracted common features and generating an output corresponding to the local dataset 211, the client computing device 210 may be further configured to use a normalized exponential function (for instance, a softargmax or softmax function), in order to output label of the local dataset 211 with probabilities.

By sharing the set of common layers 120 used to extract common features, a richer feature extractor of the model 100 can be achieved. Moreover, the set of client-specific layers 140 may be stored and updated locally by each client computing device 210, 210′, wherein these layers 140 may be adapted to unique features of the respective local dataset 211, 211′. Moreover, an accuracy of the output probabilities of the labels may be enhanced, as labels are typically disjoint across client computing devices 210, 210′, and a convergence of the model 100 on each client computing device 210, 210′ is advantageously not affected.

For example, video steaming is becoming more and more popular, however, its service providers vary in different regions of the world. In Europe, video streaming traffic could be from YouTube™, Netflix™, SkyTV™, Joyn™ etc. In the USA, video streaming traffic could be from YouTube™, Netflix™, Twitch™, Hulu™ etc. In China, video streaming traffic could be from YouKu™, TikTok™, iQiYi™ etc. No matter which service provider it is, video streaming traffic typically shares common features in terms of communication protocols, encoding methods, etc. Thus, the model 100 of the neural network, used e.g., for analyzing video streaming traffic, can be optimized by sharing and updating the set of common layers 120 globally, while keeping the set of client-specific layers 140 stored and updated locally. Sharing and updating the set of common layers 120 for extracting common features of the video streaming traffic can help the model 100 to better distinguish video streaming traffic from communication traffic of other types, while keeping the set of client-specific layers 140 stored and updated locally can improve the local/regional accuracy of the model 100 to classify video streaming providers corresponding to the region of the client computing device 210, 210′.

As such, different client computing devices 210, 210′ located in distinct environments can still cooperate to improve the model 100 of the neural network by sharing the set of common layers 120, and to achieve a richer feature extractor of the model 100. Moreover, the set of client-specific layers 140 may be stored and updated locally by each client computing device 210, 210′, wherein these layers 140 may advantageously be adapted to unique features of each respective local dataset 211, 211′ for classification.

In another embodiment, after sending the updated set of common layers 120 to the server computing device 220, the client computing device 210 may be further configured to receive an aggregated set of common layers 120 from the server computing device 220. Then the client computing device 210 may update the model 100 based on the received aggregated set of common layers 120. In particular, the client computing device 210 may concatenate the received aggregated set of common layers 120 and the updated set of client-specific layers 140 to obtain an updated model 100.

In another embodiment, after obtaining the updated model 100, the client computing device 210 may be configured to train the updated model 100 again by using the local dataset 211 and/or another local dataset (e.g., from another client computing device 210′) to obtain a further updated set common layers 120 and a further updated set of client-specific layers 140. Then the client computing device 210 may send the further updated set of common layers 120 to the server computing device 220 and may store the further updated set of client-specific layers 140.

Optionally, the training may be repeated to achieve a final model 100, which is fit for performing the specific task of machine learning. The repeating of the training may end when a mathematical condition or a criterion is fulfilled. The mathematical condition or the criterion may be a convergence of a gradient descent of the neural network.

In one embodiment, the set of client-specific layers 140 may comprise last fully connected layers of the neural network. Optionally, the set of common layers 120 may comprise convolutional layers of the neural network. Optionally, the neural network may be a convolutional neural network.

The client computing device 210 may comprise processing circuitry (not shown) configured to perform, conduct or initiate the various operations of the client computing device 210 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the client computing device 210 to perform, conduct or initiate the operations or methods described herein.

The server computing device 220 shown in FIG. 2 is accordingly configured to send the model 100 of the neural network to each of a plurality of client computing devices 210, 210′. The model 100 comprises the set of common layers 120 and the set of client-specific layers 140. Each layer of the model 100 may comprise parameters, e.g., weights and/or biases.

The server computing device 220 may initialize the model 100 by using common random initialization methods, such as drawing random values from a normal Gaussian distribution, or Xavier's algorithm (also known as Xavier's random weight initialization), or He's normal initialization (also known as He-et-al initialization) that draws samples from a truncated normal distribution, etc.

For example, for drawing random values from a normal Gaussian distribution, weights of each layer of the model 100 may be assigned with random values from a Gaussian distribution having mean 0 and a standard deviation of 1. Then, the random values may be multiplied with the square root of (2/Ni), wherein Ni is the number of input for ith layer of the model 100.

Furthermore, after the training of the model 100 is finished on each of the client computing device 210, 210′, the server computing device 220 may receive an updated set of common layers 120 from each of the client computing devices 210, 210′. An updated set of client-specific layers 140 may not be received.

Optionally, the set of common layers 120 comprises information for feature extraction, and the set of client-specific layers 140 comprises information for classification.

In another embodiment, the server computing device 220 may be further configured to aggregate the received updated sets of common layers 120 to obtain one aggregated set of common layers 120. Then, the server computing device 220 may send the aggregated set of common layers 120 to each of the plurality of client computing devices 210, 210′.

Various aggregation methods and/or functions may be applied for performing the aggregation, including but not limited to averaging (i.e., generating arithmetic mean), weighted averaging, harmonic average by generating a harmonic mean, and a maximum function taking the largest value on the received updated sets of common layers 120.

More specifically, the aggregation may be performed on each layer of the received updated set of common layers 120. Parameters for the same layer, but from different client computing devices 210, 210′, may be aggregated correspondingly by using any one of the various aggregation methods mentioned above in the server computing device 220, in order to obtain the aggregated set of common layers 120.

In another embodiment, the set of client-specific layers 140 may comprises last fully connected layers of the neural network. Optionally, the set of common layers 120 may comprise convolutional layers of the neural network. Optionally, the neural network may be a convolutional neural network.

The server computing device 220 may comprise processing circuitry (not shown) configured to perform, conduct or initiate the various operations of the server computing device 220 described herein. The processing circuitry may comprise hardware and software. The hardware may comprise analog circuitry or digital circuitry, or both analog and digital circuitry. The digital circuitry may comprise components such as ASICs, FPGAs, DSPs, or multi-purpose processors. In one embodiment, the processing circuitry comprises one or more processors and a non-transitory memory connected to the one or more processors. The non-transitory memory may carry executable program code which, when executed by the one or more processors, causes the server computing device 220 to perform, conduct or initiate the operations or methods described herein.

FIG. 2 as a whole illustrates a computing system 200 according to an embodiment of the present disclosure, which includes one or more client computing devices 210, 210′, wherein each build on the client computing device 210 described above, and at least one server computing device 220, which builds on the server computing device 220 described above. Same elements have same reference signs and functions. Therefore, they are not described again at this point.

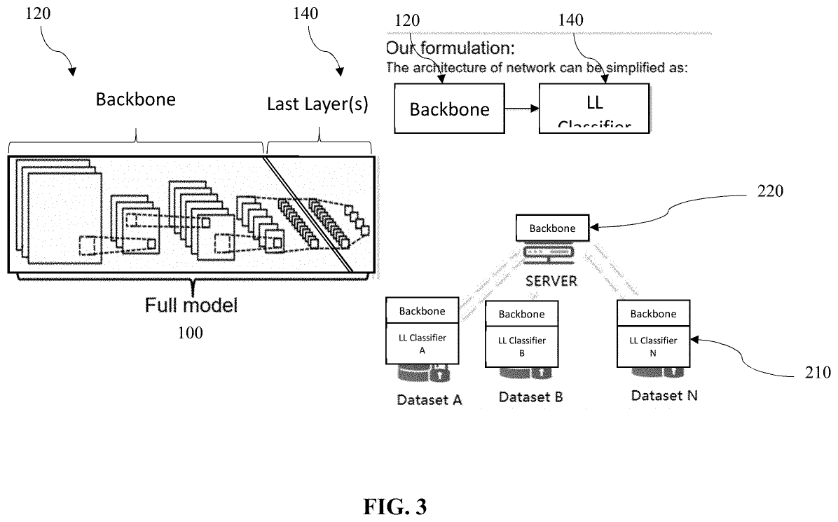

FIG. 3 illustrates a computing system 200 according to an embodiment of the present disclosure, which builds on the embodiment shown in FIG. 2. The computing system 200 accordingly comprises a server computing device 220 (“Server”) and a plurality of client devices 210 (A, B . . . N).

As stated above (and as shown on the left-hand side of FIG. 3), a contribution of this embodiment is the virtual separation of the model 100 of the neural network - here it is exemplarily a CNN network—into a set of common layers 120 and a set of client-specific layers 140. The way of separating the model 100 may be performed according to the CNN's property. Here, in this embodiment, the set of common layers 120 is referred to as “Backbone”, e.g., stacked convolutional layers, and the set of client-specific layers 140 is referred to as last layers (LL), e.g., last fully connected layers. In particular, the CNN may be a common classification network using stacked convolutional layers at the beginning, followed by fully connected layers. The LL may also be referred to as “LL Classifier”, since it/they is/are the classifier that contains class specific information. The LL may use a normalized exponential function (for instance, a softargmax or softmax function) that outputs a label with a maximum probability. The Backbone may be interpreted as feature extraction, particularly it may contain the common feature extraction procedure among the client computing devices 210.

Each client computing device 210 may share its updated Backbone (after training of the model 100 based on the local dataset 211) to the server computing device 220. Sharing the Backbones helps to learn a richer feature extractor. The Backbones may be aggregated in the server computing device 220.

Each client computing device 210 may further keep (a) specific LL layer(s) (“LL Classifier A”, “LL Classifier B” . . . “LL Classifier N”) to further adapt to a local data distribution. The updated LL Classifier is not shared back to the server computing device 220 after training of the model 100. By using this formulation, the previously stated problems can be solved.

Further, after receiving an update of the server computing device 220, each client computing device 210 may replace the local Backbone (stored at the respective client computing device 201) with a received aggregated Backbone. Thereby, the LL classifier does not participate in the aggregation performed by the server computing device 220, and may thus be kept independent between the client computing devices 210.

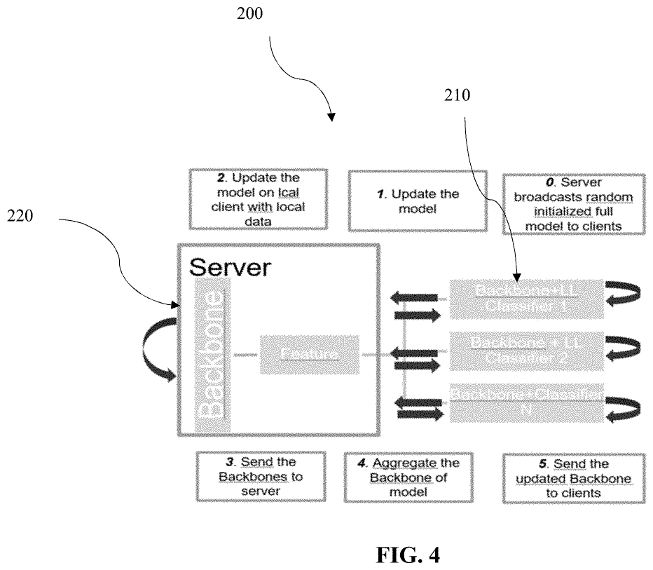

FIG. 4 illustrates a procedure implemented by a computing system 200 according to an embodiment of the present disclosure, in particular by the computing system 200 shown in FIG. 4. The computing system 200 can perform a heterogeneous data-adaptive federated learning algorithm, which may include the following steps (indicated in FIG. 4).

The whole procedure may start with Step 0, an initialization process. The server computing device 220 may initialize the model 100, e.g., randomly, by using common initialization methods (such as random initialization that draws a value from a normal Gaussian distribution, or Xavier's algorithm that specifies the variance of the distribution by the number of neurons, or He's algorithm that draws samples from a truncated normal distribution). The server computing device 220 may then broadcast this initialization to all the client computing devices 210.

For each round of communications, Step 1, the client computing devices 210 may update the local model 100 by copying the Backbone. If it is the first round of communication, the LL (Classifier) may be copied as well.

In Step 2, the client computing devices 210 may update the received model 100 on their local dataset 211, until convergence or by fixing epochs.

In Step 3, one or more of the client computing devices 210, or each client computing device 210, may send back the Backbone to the server computing device 220.

Upon receiving the Backbones from the client computing devices 210, in Step 4, the server computing device 220 aggregates the Backbones. For instance, the aggregation methods can be averaging, weighted averaging, harmonic average, maximum.

In Step 5, the server computing device 220 may then broadcast the aggregated Backbone to the client computing devices 210.

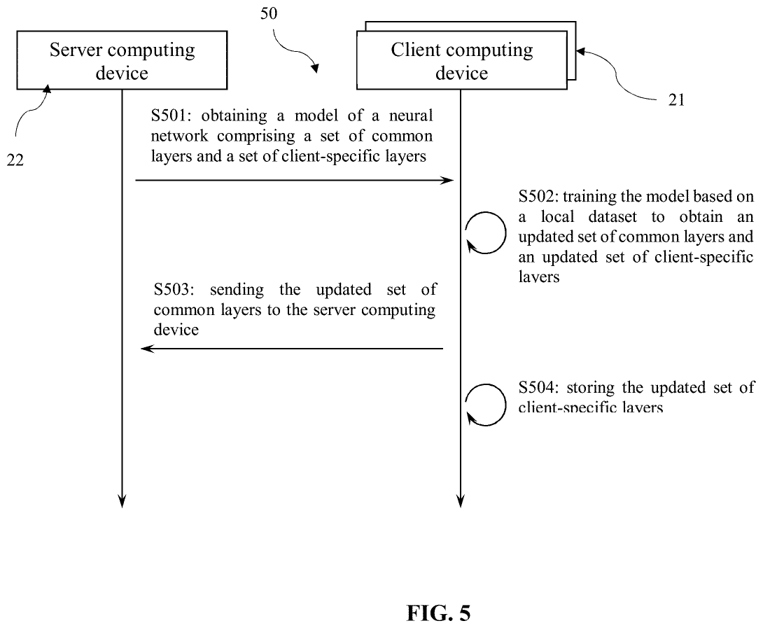

FIG. 5 illustrates a method 500 according to an embodiment of the present disclosure, which is described from the perspective of the client computing device 210.

The method 500 comprises the following steps:

S501: obtaining, by a client computing device, a model from a server computing device, wherein the model comprises a set of common layers and a set of client-specific layers,

S502: training, by the client computing device, the model based on a local dataset to obtain an updated set of common layers and an updated set of client-specific layers, wherein the local dataset is stored at the client computing device,

S503: sending, by the client computing device, the updated set of common layers to the server computing device, and

S504: storing, by the client computing device, the updated set of client-specific layers.

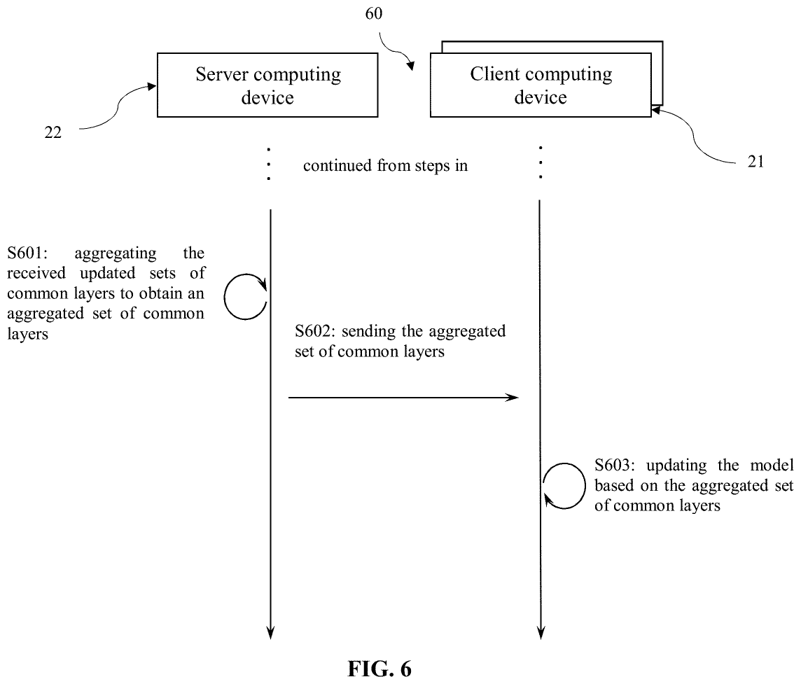

FIG. 6 illustrates that the method 500 may further comprise:

S601: aggregating, by the server computing device, the received updated sets of common layers to obtain an aggregated set of common layers,

S602: sending, by the server computing device, the aggregated set of common layers to each of the client computing devices,

S603: updating, by the client computing device, the model based on the aggregated set of common layers.

In one embodiment, the steps of S502, S503, S504, S601, S602, and S603 may be repeated multiple times, until a mathematical condition or criterion is fulfilled to achieve a final model 100 for performing the specific task of machine learning. The mathematical condition or criterion may be a convergence of a gradient descent of the neural network.

Each step of the method 500 may share the same functions and details from the perspective of the server computing device 220 described above. Therefore, the corresponding method performed by the server computing device 200 is not described again.

As describe above, an aspect of embodiments of the present disclosure is that, instead of constructing a single global Full Model (FM) 100 for N client computing devices 210, N models 100, namely one at each of the N client computing devices 210, may be constructed. Each model 100 has the same set of common layers 120 and an individual set of client-specific layers 140. In particular, the set of common layers 120 (e.g., Backbone portion) may be globally shared by the server computing device 220, whereas the set of client-specific layers 140 (e.g., N×LL portions) may be specialized for each client computing device 210 and may remain locally at the client computing devices 210, 210′.

As such, the embodiments of the present disclosure contribute as soon as, during the training process, the server computing device 220 can ensure/infer that the client computing devices 210 have a set of common layers 120 (e.g., Backbone portion) for their model 100 and a set of client-specific layers 140 (e.g., LL parts) for their model 100.

Notably, the split between common layers 120 and client-specific layers 140 does not need to be the LL only. However, given as an example a CNN structure, it may be beneficial for the client-specific layers to be the last fully convolutional layer(s) (given the input data, it may make sense to have a common feature extractor, as pooling data may speed up convergence), but this is not mandatory.

In summary, the previously described problems can be solved by the embodiments of the present disclosure. In particular, training a model 100 of a neural network, in particular common layers 120 like a CNN backbone, usually requires a large amount of data, and not every client computing device may have enough data. According to embodiments of the present disclosure, sharing the set of common layers 120 allows every client computing device 210 to benefit from the large amount of data (datasets 211, 211′) collected from all of the client computing devices 210. The client-specific layers 140, e.g., LL Classifier, have typically much less parameters, so that the local dataset 211 at each client computing device 210 is enough for training.

The local accuracy is further optimized by the embodiments of the present disclosure, to ensure a best performance for imbalanced distributed data at the various client computing devices 210. The client-specific layers 140 (e.g., LL Classifier) allow the model 100 to adapt quickly to local client computing device's distribution, despite the imbalanced data distribution existing between client computing devices 210.

The set of common layers 120 (e.g., Backbone) can be seen as a common feature extraction process. Although multi modal signals may exist in a local client computing device 210, independent client-specific layers 140 (e.g., LL Classifier) can select corresponding features for different signals.

The client-specific layers 140 (e.g., LL Classifier) is not used for the aggregation, hence, even if labels are disjoint, the convergence will not be affected.

The present disclosure has been described in conjunction with various embodiments as examples as well as implementations. However, other variations can be understood and effected by those persons skilled in the art and practicing the disclosed embodiments, from the studies of the drawings, and the independent claims. In the claims as well as in the description the word “comprising” does not exclude other elements or steps and the indefinite article “a” or “an” does not exclude a plurality. A single element or other unit may fulfil the functions of several entities or items recited in the claims. The mere fact that certain measures are recited in the mutual different dependent claims does not indicate that a combination of these measures cannot be used in an advantageous implementation.

1. A client computing device comprising:
a data storage unit;
a memory configured to store instructions; and
a processor coupled to the memory and configured to execute the instructions to cause the client computing device to:
store a local dataset in the data storage unit;
obtain a model of a neural network from a server computing device, wherein the model comprises a set of common layers and a set of client-specific layers;
train the model based on the local dataset to obtain an updated set of common layers and an updated set of client-specific layers;
send the updated set of common layers to the server computing device; and
store the updated set of client-specific layers.

2. The client computing device according to claim 1, wherein the set of common layers comprises feature-extraction information, and wherein the set of client-specific layers comprises classification information.

3. The client computing device according to claim 1, wherein, for training the model based on the local dataset to obtain the updated set of common layers and the updated set of client-specific layers, the processor is further configured to execute the instructions to cause the client computing device to:
perform feature extraction on the local dataset using the set of common layers to obtain extracted features of the local dataset; and
perform classification of the extracted features of the local dataset using the set of client-specific layers.

4. The client computing device according to claim 3, wherein, for performing the classification of the extracted features of the local dataset, the processor is further configured to execute the instructions to cause the client computing device to use a normalized exponential function to output labels of the local dataset with probabilities.

5. The client computing device according to claim 1, wherein the processor is further configured to execute the instructions to cause the client computing device to:
receive an aggregated set of common layers from the server computing device; and
update the model based on the aggregated set of common layers.

6. The client computing device according to claim 5, wherein, for updating the model based on the aggregated set of common layers, the processor is further configured to execute the instructions to cause client computing device to concatenate the aggregated set of common layers and the updated set of client-specific layers.

7. The client computing device according to claim 1, wherein the set of client-specific layers comprises last fully connected layers of the neural network, and/or wherein the set of common layers comprises convolutional layers of the neural network.

8. A server computing device comprising:
a memory configured to store instructions; and
a processor coupled to the memory and configured to execute the instructions to cause the server computing device to:
send a model of a neural network to each of a plurality of client computing devices, wherein the model comprises a set of common layers and a set of client-specific layers; and
receive, from each of the plurality of client computing devices, an updated set of common layers.

9. The server computing device according to claim 8, wherein the set of common layers comprises feature-extraction information, and the set of client-specific layers comprises classification information.

10. The server computing device according to claim 8, wherein the processor is further configured to execute the instructions to cause the server computing device to aggregate the received updated sets of common layers to obtain an aggregated set of common layers; and send the aggregated set of common layers to each of the plurality of client computing devices.

11. The server computing device according to claim 10, wherein, for aggregating the received updated sets of common layers to obtain the aggregated set of common layers, the processor is further configured to execute the instructions to cause server computing device to perform an average function, a weighted average function, a harmonic average function, or a maximum function on the received updated sets of common layers.

12. The server computing device according to claim 8, wherein the set of client-specific layers comprises last fully connected layers of the neural network and/or wherein the set of common layers comprises convolutional layers of the neural network.

13. A method implemented by a client computing device, the method comprising:
storing a local dataset;
obtaining a model of a neural network from a server computing device, wherein the model comprises a set of common layers and a set of client-specific layers;
training the model based on the local dataset to obtain an updated set of common layers and an updated set of client-specific layers;
sending, to the server computing device, the updated set of common layers; and
storing the updated set of client-specific layers.

14. The method according to claim 13, wherein the set of common layers comprises feature extraction information, and wherein the set of client-specific layers comprises classification information.

15. The method according to claim 13, wherein the method further comprises:
performing feature extraction on the local dataset using the set of common layers to obtain extracted features of the local dataset; and
performing classification of the extracted features of the local dataset using the set of client-specific layers.

16. The method according to claim 15, wherein the method further comprises using a normalized exponential function to output labels of the local dataset with probabilities.

17. The method according to claim 13, wherein the method further comprises:
receiving an aggregated set of common layers from the server computing device; and
updating the model based on the aggregated set of common layers.

18. The method according to claim 17, wherein the method further comprises concatenating the aggregated set of common layers and the updated set of client-specific layers.

19. The method according to claim 13, wherein the set of client-specific layers comprises last fully connected layers of the neural network.

20. The method according to claim 19, wherein the set of common layers comprises convolutional layers of the neural network.
